(19) United States
(12) Patent Application Publication
(10) Pub. No.: US 2025/0387921 A1
(43) Pub. Date: Dec. 25, 2025

(54) SENSING SYSTEM FOR GRIP CONTROL, GRIPPING APPARATUS, ROBOT APPARATUS AND CONTROL METHOD FOR SAME

(71) Applicant: Sony Group Corporation, Tokyo (JP)

(72) Inventors: Tetsuro GOTO, Tokyo (JP); Ken KOBAYASHI, Kanagawa (JP); Hayato HASEGAWA, Kanagawa (JP); Yoshiaki SAKAKURA, Kanagawa (JP); Manami MIYAWAKI, Kanagawa (JP); Kei TSUKAMOTO, Kanagawa (JP)

(21) Appl. No.: 18/880,679

(22) PCT Filed: Jun. 28, 2023
(86) PCT No.: PCT/JP2023/023901

§ 371 Date: Jan. 2, 2025

(30) Foreign Application Priority Data
Jul. 25, 2022 (JP) 2022-118100

(51) Int. Cl. B25J 13/08; B25J 9/16; B25J 15/00

(52) U.S. Cl. CPC B25J 13/082; B25J 9/1612; B25J 15/0004

(57) ABSTRACT

There is provided an apparatus including: a hand portion with a plurality of finger portions respectively having gripping surfaces capable of gripping a work; a sensor unit provided in at least one of the plurality of finger portions and capable of detecting a pressure distribution on the gripping surface; and a control apparatus configured to detect a slip of the work on the gripping surface on the basis of an output of the sensor unit and generate a control command to change a relative position of the hand portion with respect to the work.

### CROSS REFERENCE TO RELATED APPLICATIONS

This application claims the benefit of Japanese Priority Patent Application JP 2022-118100 filed Jul. 25, 2022, the entire contents of which are incorporated herein by reference.

### TECHNICAL FIELD

The present technology relates to an apparatus equipped with a hand portion having a sensing system and to a control method therefor.

### BACKGROUND ART

In recent years, work automation using robots in various scenes has been studied along with a decrease in worker population. It is necessary to detect how much degree of force is acting on a surface of a robot hand in order to accurately control behaviors of the robot hand. For example, Patent Literature 1 below has disclosed a robot hand equipped with a tactical force sensor capable of detecting not only a compression force but also a shearing stress or slip friction.

### CITATION LIST

### Patent Literature

PTL 1: Japanese Patent Application Laid-open No. 2019-2905

### SUMMARY

### Technical Problem

As for work of a robot hand or the like, a work slip in the hand directly leads to a failure such as work fall and position deviation (yield lowers). Therefore, control to prevent the work slip in the hand is generally performed. In practice for example the work is placed at a middle point of a jig, the band is moved away, and the work is regripped as a method for changing a gripping direction of the work.

However, this method takes time to place the work at the middle point and regrip it. It is a big problem in terms of the working speed and takes time.

In view of the above-mentioned circumstances, it is an objective of the present technology to provide a robot apparatus, which is capable of changing the gripping direction without regripping a work, and a control method therefor.

### Solution to Problem

An apparatus according to an embodiment of the present technology includes a hand portion, a sensor unit, and a control apparatus.

The hand portion includes a plurality of finger portions respectively having gripping surfaces capable of gripping a work.

The sensor unit is provided in at least one of the plurality of finger portions and capable of detecting a pressure distribution on the gripping surface.

The control apparatus is configured to detect a slip of the work on the gripping surface on the basis of an output of the sensor unit and generate a control command to change a relative position of the hand portion with respect to the work.

In one example embodiment, a robot apparatus is capable of changing a gripping direction without regripping a work because it detects a slip of the work on the gripping surface on the basis of an output of the sensor unit capable of detecting a pressure distribution on the gripping surface and changes a relative position of the hand portion with respect to the work.

The sensor unit may be constituted by an elastically deformable sensor sheet having a plurality of capacitive elements that detects a pressure acting on the gripping surface, and the control apparatus may be configured to detect the slip of the work on the gripping surface on the basis of a change over time in pressure detected by the plurality of capacitive elements.

The control apparatus may be configured to detect the slip of the work on the gripping surface when the number of capacitive elements whose pressure detection value has changed within a predetermined time becomes a predetermined number or more.

The control apparatus may be configured to detect the slip of the work on the gripping surface when a pressure center position or a pressure distribution calculated on the basis of pressure detection values of the plurality of capacitive elements changes within a predetermined time.

The control apparatus may be configured to generate, as the control command, from a state of gripping the work with a first gripping force, a pressure adjustment command to adjust the work from the first gripping force to a second gripping force lower than the first gripping force and a movement command to change the relative position of the hand portion with respect to the work.

The control apparatus may be configured to generate, as the movement command, a control command to change from a first attitude in which a distal end of the hand portion is oriented downward in a gravity direction to a second attitude in which the distal end of the hand portion is oriented in a direction orthogonal to the gravity direction.

The control apparatus may be configured to generate, as the movement command, a control command to move in a longitudinal direction of the work.

The sensor sheet may be constituted by a pressure sensor, the pressure sensor including a sensor electrode layer in which the plurality of capacitive elements is arranged in a matrix form, a reference electrode layer connected to a reference potential, and a deformation layer disposed between the sensor electrode layer and the reference electrode layer.

The sensor sheet may include a pair of pressure sensors, the pressure sensors each having a sensor electrode layer in which the plurality of capacitive elements is arranged in a matrix form, a reference electrode layer connected to a reference potential, and a deformation layer disposed between the sensor electrode layer and the reference electrode layer, and a separation layer constituted by a viscoelastic material disposed between the pair of pressure sensors.

A control method for an apparatus according to an embodiment of the present technology includes: detecting a slip of a work on a gripping surface on the basis of an output of a sensor unit capable of detecting a pressure distribution on the gripping surface of a hand portion capable of gripping the work; and generating a control command to change a relative position of the hand portion with respect to the work.

### BRIEF DESCRIPTION OF DRAWINGS

FIG. 1 is a main-part perspective view showing a robot apparatus according to an example embodiment of the present technology.

FIG. 2 is a schematic side cross-sectional view showing a cross-section structure of a sensor sheet that is a configuration example of a sensor unit in the robot apparatus.

FIG. 3 is a schematic plan view showing a sensor electrode layer in the sensor sheet.

FIG. 4 is a main-part plan view showing a configuration example of a sensing portion in the sensor sheet.

FIG. 5 is a schematic side cross-sectional view showing another configuration example of the sensor unit.

FIG. 6 is a block diagram showing configurations of a control unit 70.

FIG. 7 is a block diagram showing configurations of a control apparatus in the robot apparatus.

FIG. 8 is a flowchart showing an example of a gross slip detection procedure of a work to be executed by the control apparatus.

FIG. 9 is a block diagram showing an example of a control system of the robot apparatus.

FIG. 10 is a schematic view describing an operation example of the robot apparatus.

FIG. 11 is a flowchart showing an operation procedure of the robot apparatus shown in FIG. 10.

FIG. 12 is a flowchart showing the operation procedure of the robot apparatus shown in FIG. 10.

FIG. 13 is a schematic view describing another operation example of the robot apparatus.

FIG. 14 is a flowchart showing an operation procedure of the robot apparatus shown in FIG. 13.

FIG. 15 A flowchart showing the operation procedure of the robot apparatus shown in FIG. 13.

### DESCRIPTION OF EMBODIMENTS

Hereinafter, embodiments according to the present technology will be described with reference to the drawings.

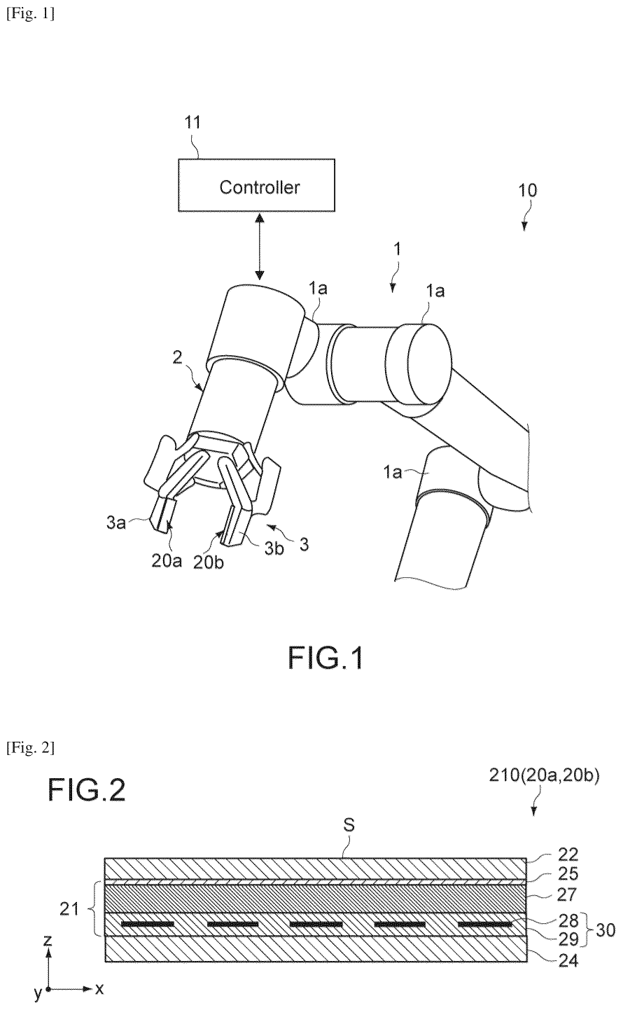

FIG. 1 is a main-part perspective view showing a robot apparatus 10 according to an example embodiment of the present technology. In the present embodiment, the robot apparatus 10 constitutes robot hands. Hereinafter, configurations of the robot apparatus 10 will be described schematically. It should be understood that the present disclosure may be embodied in the illustrated example of a robotic arm, or may alternatively be embodied in different implementations or applications of this technology, involving manipulations of any manner of work (e.g., paintbrush, screwdriver, clamp, etc.).

### Robot Apparatus

As shown in FIG. 1, the robot apparatus 10 includes arm portions 1, wrist portions 2, and hand portions 3.

The arm portion 1 includes a plurality of joint portions 1a. Driving the joint portions 1a enables the arm portion 1 to move the hand portion 3 to any position. The wrist portion 2 is rotatably connected to the arm portion 1. Rotation of the wrist portion 2 can rotate the hand portion 3.

The hand portion 3 has a plurality of finger portions. The plurality of finger portions is capable of gripping a gripping target object (work). In the present embodiment, the hand portion 3 has two finger portions 3a, 3b opposite to each other. Driving the two finger portions 3a, 3b enables the hand portion 3 to grip the work between the two finger portions 3a, 3b. Note that the number of finger portions can be changed as appropriate. For example, three or four or more finger portions may be provided.

The two finger portions 3a, 3b have surfaces facing each other. The surfaces of the two finger portions 3a, 3b include sensor units 20a, 20b, respectively. The sensor units 20a, 20b have pressure detection surfaces. The pressure detection surfaces are configured to be capable of detecting pressure components added in a direction perpendicular to the pressure detection surfaces and an in-plane distributions of the pressure components. Moreover, the sensor units 20a, 20b may be three-axis sensors capable of detecting shearing forces parallel to the pressure detection surfaces and an in-plane distribution of the shearing forces as well as the pressure distribution. Both the finger portions 3a, 3b may include the sensor units 20a, 20b. Alternatively, only either one of the finger portions may include the sensor unit. Note that configurations of the sensor units 20a, 20b will be described later with reference to FIG. 2, etc.

A controller 11 controls driving of the robot apparatus 10. The controller 11 includes a control unit and a storage unit for example. The control unit is for example a central processing unit (CPU). Based on a program stored in the storage unit, the control unit controls driving of the respective portions of the robot apparatus 10. The controller 11 may be an apparatus dedicated to the robot apparatus 10 or may be a universal apparatus. The controller 11 may be a personal computer (PC) connected to the robot apparatus 10 with a wire or wirelessly, a server apparatus in a network, or the like. The controller 11 may be a part of the robot apparatus 10.

### Sensor unit

Next, the sensor units 20a, 20b will be described in detail. The sensor units 20a, 20b have the same configuration. The sensor unit 20a, 20b is constituted by a sensor sheet capable of detecting a pressure distribution on the pressure detection surfaces.

### Configuration Example 1

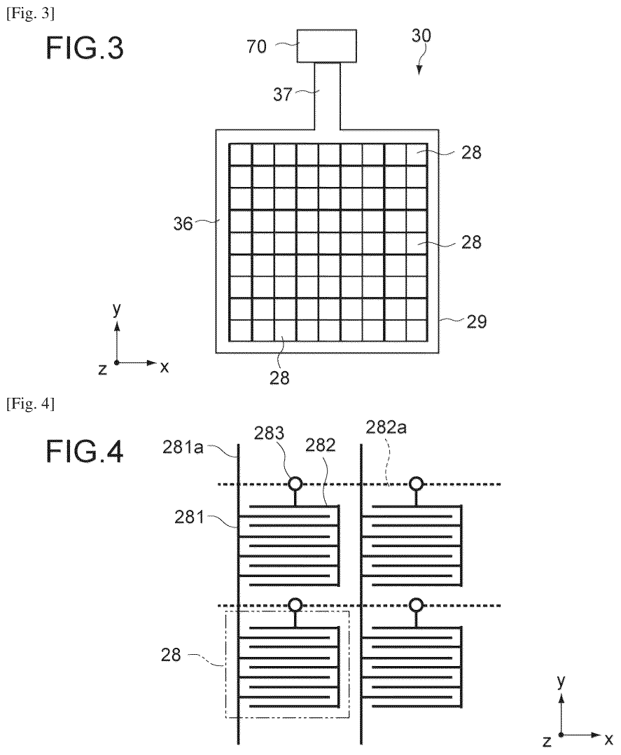

FIG. 2 is a schematic side cross-sectional view showing a cross-section structure of the sensor sheet 210 that is a configuration example of the sensor unit 20a, 20b. FIG. 3 is a schematic plan view showing a sensor electrode layer 30 of the sensor sheet 210. In one example, the sensor sheet 210 may be in a sensing system for grip control in a gripping apparatus, such as the robot apparatus of FIG. 1, or in another alternate embodiment as discussed further below.

In FIGS. 2 and 3, the x-axis direction and the y-axis direction are directions parallel to a pressure detection surface S of the sensor sheet 210 (hereinafter, also referred to as in-plane directions). The z-axis direction is a direction perpendicular to the pressure detection surface S (hereinafter, also referred to as a perpendicular direction). In FIG. 2, the upper side corresponds to a front side on which an external force is added. The lower side corresponds to a rear side opposite to the front side.

The sensor sheet 210 bas a generally rectangular flat plate shape in a planar view. Note that the shape of the sensor sheet 210 in a planar view only needs to be set as appropriate depending on a shape of a portion where the sensor unit 20a, 20b is disposed and can be any other shape. For example, the shape of the sensor sheet 210 in a planar view may be a polygonal shape, a circular shape, or an elliptical shape other than the rectangular shape.

As shown in FIG. 2, the sensor sheet 210 is configured as a laminate including a pressure sensor 21, a surface layer 22, and a supporting layer 24. The surface layer 22 is disposed on the upper surface of the pressure sensor 21. The supporting layer 24 is disposed on the lower surface of the pressure sensor 21.

The pressure sensor 21 includes the sensor electrode layer 30, a reference electrode layer 25, and a deformation layer 27. The deformation layer 27 is disposed between the sensor electrode layer 30 and the reference electrode layer 25.

The sensor electrode layer 30 includes a flexible printed board and the like. The sensor electrode layer 30 has a main body portion 36 and a pull-out portion 37 as shown in FIG. 3. The main body portion 36 has a rectangular shape in a planar view. The pull-out portion 37 extends outward from the main body portion 36. Note that the shape of the sensor electrode layer 30 in a planar view is not limited to the rectangular shape and can be changed as appropriate.

The sensor electrode layer 30 includes a base material 29 and a plurality of sensing portions 28. The base material 29 is flexible. The plurality of sensing portions 28 is provided on or in the surface of the base material 29. For example, the base material 29 is made of a polymer resin such as polyethylene terephthalate, polyimide, polycarbonate, and acrylic resin. The sensing portions 28 are regularly arranged in a matrix form at predetermined vertical and horizontal intervals (vertical: the y-axis direction, horizontal: the x-axis direction). In the example shown in FIG. 3, the number of sensing portions 28 is a total of 81=9×9 (vertical×horizontal). Note that the number of sensing portions 28 can be changed as appropriate.

The sensing portions 28 include a plurality of capacitive elements (detection elements) capable of detecting changes in distance from the reference electrode layer 25 as capacitance changes. The sensing portions 28 has for example comb-like pulse electrodes 281 and comb-like sense electrodes 282 as shown in FIG. 4. The comb-like pulse electrodes 281 and the comb-like sense electrodes 282 are disposed with the comb teeth facing each other. Each sensing portion 28 includes a region (node area) where one comb teeth are disposed to mesh with the other comb teeth. Each pulse electrode 281 is connected to a wiring portion 281a extending in the y-axis direction. Each sense electrode 281 is connected to a wiring portion 282a extending in the x-axis direction. The wiring portions 281a are arranged in the x-axis direction on the surface of the base material 29. The wiring portions 282a are arranged in the y-axis direction on the back surface of the base material 29. Each sense electrode 282 is electrically connected to the wiring portion 282a via a through-hole 283 formed in the base material 29. The sensor electrode layer 30 may have a grounding wire. The grounding wire is provided in for example an outer peripheral portion of the sensor electrode layer 30 or a portion where the wiring portions 281a, 282a extend together.

Note that the sensing portions 28 may have any structure other than example. For example, the sensor electrode layer 30 may be configured as a laminate of a first electrode sheet and a second electrode sheet. The first electrode sheet has a grid-like first electrode pattern extending in the x-axis direction. The second electrode sheet has a grid-like second electrode pattern extending in the y-axis direction. In this case, the sensing portion 28 is formed at a crossing portion of the first electrode pattern and the second electrode pattern.

The reference electrode layer 25 is connected to a reference potential. In the present embodiment, the reference electrode layer 25 is a so-called ground electrode and connected to a ground potential. The reference electrode layer 25 is flexible. The reference electrode layer 25 has a thickness of approximately 0.05 μm to 0.5 μm for example.

For example, the reference electrode layer 25 is made of an inorganic conductive material, an organic conductive material, or a conductive material containing both an inorganic conductive material and an organic conductive material.

Examples of the inorganic conductive material include metals such as aluminum, copper, and silver, alloys such as stainless steel, and metal oxides such as a zinc oxide and an indium oxide. Examples of the organic conductive material include carbon materials such as carbon black and carbon fibers and conductive polymers such as substituted or non-substituted polyaniline and polypyrrole. The reference electrode layer 25 may include a metal thin plate such as stainless steel and aluminum, conductive fibers, a conductive non-woven fabric, and the like. The reference electrode layer 25 may be formed by a method such as vapor deposition, sputtering, adhesion, and application on the plastic film for example.

The deformation layer 27 is disposed between the sensor electrode layer 30 and the reference electrode layer 25. The deformation layer 27 has a thickness of approximately 100 μm to 1000 μm for example. The deformation layer 27 is configured to be elastically deformable due to an external force. Application of an external force in a direction perpendicular to the sensor sheet 210 elastically deforms the deformation layer 27 while moving the reference electrode layer 25 closer to the sensor electrode layer 30. At this time, the capacitances between the pulse electrodes 281 and the sense electrodes 282 change in the sensing portions 28. Therefore, the sensing portions 28 can detect the capacitance changes as pressure values.

The thickness of the deformation layer 27 is set to be more than 100 μm and 1000 μm or less for example. The deformation layer 27 has weight per unit area of 50 mg/cm² or less for example.

Setting the thickness and the weight per unit area of the deformation layer 27 within such a range can improve the perpendicular detection sensitivity of the pressure sensor 21.

The lower limit value of the thickness of the deformation layer 27 is not particularly limited as long as it is more than 100 μm. For example, the lower limit value may be 150 μm or more, 200 μm or more, 250 μm or more, or 300 μm or more. The upper limit value of the thickness of the deformation layer 27 is not particularly limited as long as it is 1000 μm or less. For example, the upper limit value may be 950 μm or more, 900 μm or less, 850 μm or less, or 800 or less.

The deformation layer 27 may have a patterning structure including for example a column structure in order to achieve easier deformation in the z-axis direction. The patterning structure includes a column structure for example. The patterning structure can include various structures such as a matrix structure, a stripe structure, a mesh structure, a radial structure, a geometric structure, and a spiral structure.

The surface layer 22 is made of any flexible material selected from a plastic film, a woven fabric, a non-woven fabric, rubber, leather, and the like. The surface layer 22 may be configured as a contact surface that comes into contact with a work when the robot apparatus 10 grips the work with the finger portions 3a, 3b. In this case, the surface layer 22 functions as a pressure detection surface that receives a load (reaction force of the gripping force) from the work during the gripping operation. Therefore, the surface layer 22 favorably has surface properties that can add a predetermined frictional force or more to the work in order to grip the work stably.

The supporting layer 24 supports the pressure sensor 21. The supporting layer 24 functions as a bonding layer fixed to the surface of the finger portion 3a, 3b for example. The supporting layer 24 includes a viscous layer, e.g., a double sided tape.

A control unit 70 is mounted on the pull-out portion 37 of the sensor electrode layer 30. The control unit 70 calculates a force in the in-plane direction on the basis of information about a pressure detected by the pressure sensor 21. The control unit 70 is typically a computer including a central processing unit (CPU). The control unit 70 includes an integrated circuit such as an IC chip. The control unit 70 is mounted on the sensor electrode layer 30 (pull-out portion 37) so as to drive the pressure sensor 21. The control unit 70 is configured to receive an input of a signal output from the pressure sensor 21. Note that the control unit 70 may be mounted on a position other than the sensor electrode layer 30.

### Configuration Example 2

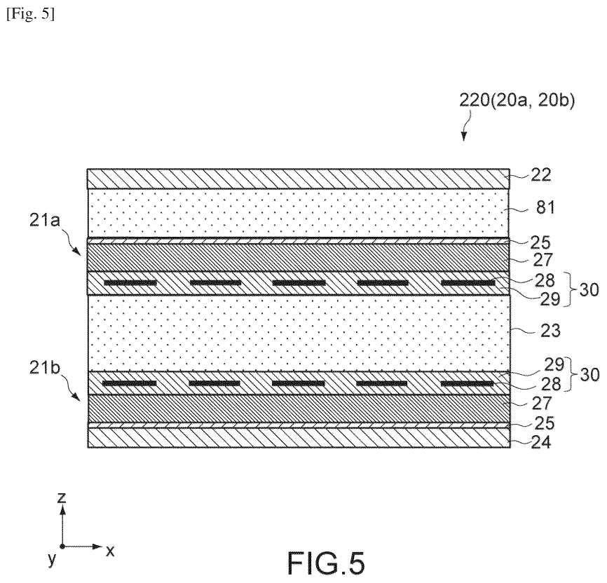

FIG. 5 is a schematic side cross-sectional view showing a cross-section structure of a sensor sheet 220 that is another configuration example of the sensor unit 20a, 20b. Note that portions corresponding to those of the configuration example 1 will be denoted by the same reference signs and detailed descriptions of the portions will be omitted. In one example, the sensor sheet 210 may be in a sensing system for grip control in a gripping apparatus, such as the robot apparatus of FIG. 1, or in another alternate embodiment as discussed further below.

The sensor sheet 220 includes a first pressure sensor 21a, a second pressure sensor 21b, and a separation layer 23. The first pressure sensor 21a is located on the front side (work side). The second pressure sensor 21b is located on the rear side (finger portions 3a, 3b side). The separation layer 23 is disposed between the first pressure sensor 21a and the second pressure sensor 21b. That is, the sensor sheet 220 has a stacking structure. In the stacking structure, the second pressure sensor 21b, the separation layer 23, and the first pressure sensor 21a are stacked in the stated order from the bottom in the perpendicular direction. The first pressure sensor 21a and the second pressure sensor 21b have the same configuration or substantially the same configuration as. Therefore, their descriptions will be omitted.

The sensor sheet 220 further has a viscoelastic body layer 81 disposed on the upper side (surface side) of the first pressure sensor 21a. The viscoelastic body layer 81 is made of a material deformable due to an external force. Examples of the deformable material include silicon gel, urethane gel, synthetic rubber, and foam. Note that the viscoelastic body layer 81 may be omitted as unnecessary.

The sensor sheet 220 detects a force (shearing force Fs) added to the sensor sheet 220 in the in-plane direction on the basis of a pressure center position (pressure detection position) of the first pressure sensor 21a in the in-plane direction and a pressure center position (pressure detection position) of the second pressure sensor 21b in the in-plane direction. The sensor sheet 220 detects a force (load Fz) added in the direction perpendicular to the sensor sheet 220 from above on the basis of a pressure value detected by the first pressure sensor 21a.

The separation layer 23 is fixed between the first pressure sensor 21a and the second pressure sensor 21b via an adhesive layer (not shown). The separation layer 23 is constituted by a viscoelastic material deformable due to a load added to the first pressure sensor 21a via the surface layer 22 and the viscoelastic body layer 81. Examples of this kind of viscoelastic material include silicon gel, urethane gel, synthetic rubber, and foam. The separation layer 23 can have any thickness. For example, the separation layer 23 has a thickness of 1000 μm or more and 5000 μm or less. The thickness of the separation layer 23 is set depending on the thickness of the viscoelastic body layer 81 for example. The separation layer 23 can have any planar shape. The separation layer 23 is typically rectangular or circular.

### Control Apparatus (Sensing System for Grip Control)

The control unit 70 includes a control unit and a storage unit for example, to control a gripping apparatus. The control unit is a central processing unit (CPU) for example. The control unit controls driving of the respective portions of the band portion 3 by executing a program stored in the storage unit in accordance with a control command from the controller 11. Typically, the control unit 70 acquires information about forces in three-axis directions detected by the sensor units 20a, 20b and controls driving of the hand portion 3 on the basis of the information about the forces to stably grip a target object with a suitable gripping force.

In the present embodiment, the control unit 70 is configured as a control apparatus. The control apparatus detects a slip of the work on the gripping surface (pressure detection surface S) on the basis of the outputs of the sensor units 20a, 20b. The control apparatus generates a control command to change a relative position of the hand portion 3 with respect to the work. For example, a position of the work is adjusted or changed relative to one or more parts of the hand portion, such as one or more finger portions 3a, 3b, etc. Thus, the position of the work in the hand portion is changed relative to the position or orientation of at least part of the hand portion.

The storage unit includes a nonvolatile memory for storing various programs and data necessary for processing of the control unit and a volatile memory used as a working area for the control unit. The various programs may be read from a portable recording medium such as a semiconductor memory. Alternatively, the various programs may be downloaded from a server apparatus in a network.

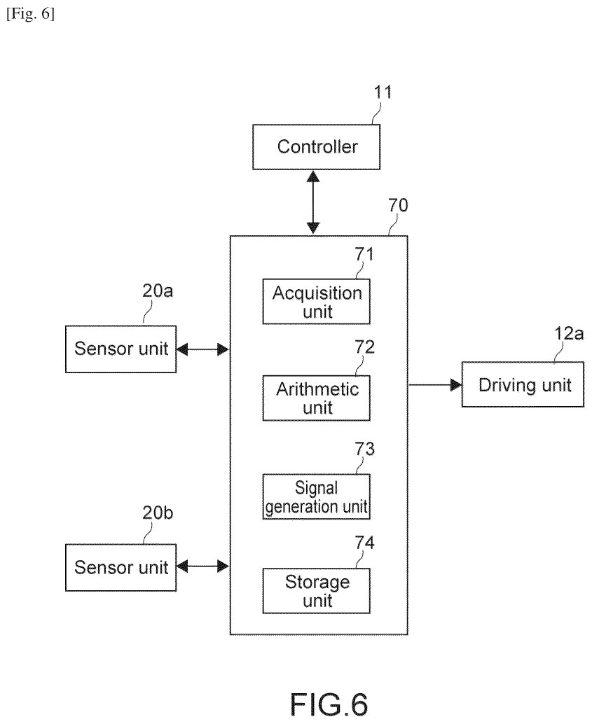

FIG. 6 is a block diagram showing configurations of the control unit 70.

The control unit 70 is electrically connected to the sensor units 20a, 20b. The control unit 70 is configured to calculate pressures acting on the respective finger portions 3a, 3b and an in-plane distribution of the pressures on the basis of the outputs of the sensor units 20a, 20b. The control unit 70 is also electrically connected to the controller 11. The control unit 70 outputs a gripping command to a driving unit 12a in accordance with the control command from the controller 11. The driving unit 12a drives the finger portions 3a, 3b of the hand portion 3.

The controller 11 and the control unit 70 are configured as a control apparatus that controls operations of the hand portions 3. In the present embodiment, the control unit 70 generates the gripping command to the driving unit 12a that drives the finger portions 3a, 3b. Alternatively, the controller 11 that controls general operations of the robot apparatus 10 may instead generate the gripping command.

In this case, the controller 11 is configured as a control apparatus.

As shown in FIG. 6, the control unit 70 includes an acquisition unit 71, an arithmetic unit 72, a signal generation unit 73, and a storage unit 74.

The acquisition unit 71 receives a pressure detection position output from each sensor unit 20a, 20b, its pressure value, and a control command output from the controller 11. The pressure information including the pressure detection position output from each sensor unit 20a, 20b and its pressure value is information about stress detected at the time of contact of the hand portion 3 (finger portion 3a, 3b) with the work and stress acting on the sensor unit 20a, 20b when the hand portion 3 (finger portion 30a, 30b) is the gripping work. The acquisition unit 71 periodically acquires the pressure information at a predetermined frame rate (sampling rate).

The arithmetic unit 72 calculates an in-plane distribution of pressures acting on the pressure detection surface S that is the gripping surface on the basis of pressure detection positions of the sensor units 20a, 20b in the in-plane direction and their pressure values. A load perpendicular to the pressure detection surface S is calculated based on the sum of normal loads acquired in the respective sensing portions 28 of the sensor unit 20a, 20b for example. Note that in a case where the sensor unit 20a, 20b is constituted by the sensor sheet 220 as shown in FIG. 5, the arithmetic unit 72 also calculates a distribution of shearing forces in the in-plane direction of the pressure detection surface S.

The signal generation unit 73 generates a control command other than the gripping command to cause the hand portion 3 to grip the work in accordance with the control command from the controller 11. The control command includes a movement command to change the relative position of the hand portion 3 with respect to the work. This gripping command includes information about a gripping force of the hand portion 3 with respect to the work. The signal generation unit 73 outputs the generated gripping command or movement command to the driving unit 12a of the hand portion 3.

The gripping command includes a high gripping command (high gripping command value) applied at the time of transportation of the work, a low gripping command (low gripping command value) to relatively move the hand portion 3 with respect to the work in the state of gripping the work, a minimum-pressure gripping command (minimum gripping force), a gripping cancelling command, and the like. The high gripping command is a gripping force (first gripping force) enough to stably grip the work without causing the work to slip. The low gripping command refers to a gripping force (second gripping force) lower than the high gripping command value and allowing the work to slip with respect to the hand portion 3 due to the work's own weight for example. The minimum-pressure gripping command is the minimum pressure value lower than the low gripping command value and capable of gripping the work so as to prevent work fall. The slip of the work includes a partial slip and a general slip. Hereinafter, the general slip of the work with respect to the hand portion 3 will be also referred to as a “gross slip”.

The movement command refers to a command (e.g., rotation, linear movement) that changes the relative position of the hand portion 3 with respect to the work for the purpose of changing the gripping position and gripping attitude of the work.

The driving unit 12a is an actuator that moves the finger portion 3a, 3b between a gripping position and a non-gripping position. In the present embodiment, the driving unit 12a is constituted by a pulse motor capable of fine feed control for example.

The storage unit 74 is typically constituted by a semiconductor memory. The storage unit 74 stores a program and various parameters for executing a processing procedure of calculating a distribution of shearing forces in the in-plane direction on the basis of the pressure detection position in the in-plane direction according to the first pressure sensor 21a and the second pressure sensor 21b.

The control unit 70 detects a slip of the work on the gripping surface on the basis of a change over time in pressure detected by the plurality of sensing portions 28. In the present embodiment, the control unit 70 detects a slip of the work on the gripping surface when the number of sensing portions 28 whose pressure detection value has changed within a predetermined time becomes a predetermined number or more as will be described later.

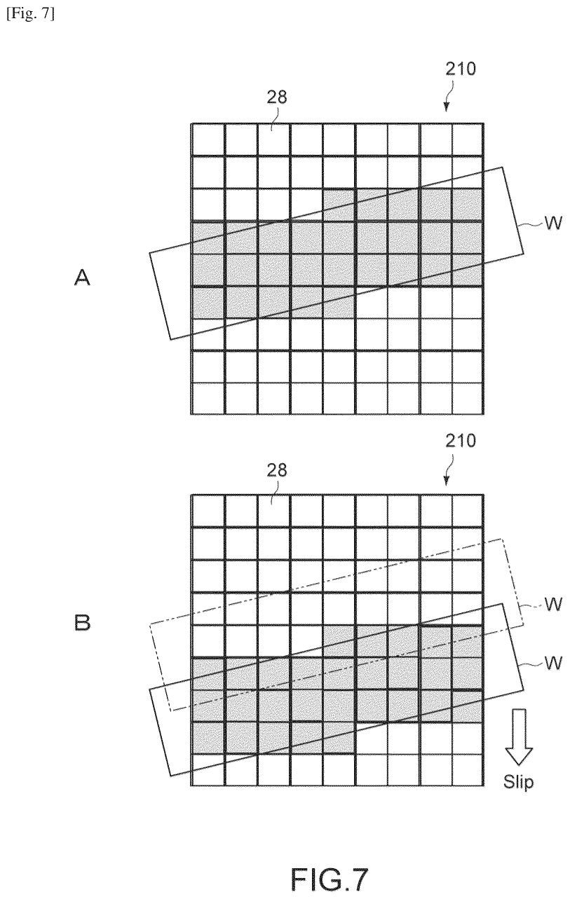

For example, A and B of FIG. 7 are schematic views of the sensor sheet 210 describing a slip of a work W on the gripping surface (pressure detection surface S). In A and B of FIG. 7, the node area as the hatched portion shows sensing portions 28 in an on-state that output pressure detection values equal to or higher than a predetermined threshold by receiving reaction of a gripping force to the work W. Other node areas (unhatched portions) show sensing portions 28 in an off-state that output pressure detection values below threshold.

When the work W gripped with a predetermined gripping force slips in a gravity direction (in the figure, downward) as shown in B of FIG. 7 from the state shown in A of FIG. 7, the outputs of the sensing portions 28 change from the on-state to the offstate or from the off-state to the on-state in a slip direction of the work W. The control unit 70 determines whether or not the number of sensing portions 28 whose on/off state has changed within the predetermined time becomes a predetermined number or more. In a case where the control unit 70 determines that it becomes the predetermined number or more, the control unit 70 detects a slip of the work W on the gripping surface. For example an exclusive or (XOR) circuit can determine the change of the on/off-state. predetermined time can be set as appropriate depending on the frame rate and can be for example several frames to several tens of frames.

As another method, the arithmetic unit 72 may be configured to detect a slip of the work W on the gripping surface when a pressure center position or a pressure distribution calculated on the basis of the pressure detection values of the plurality of sensing portions 28 has changed within the predetermined time. The pressure center position can be calculated by arithmetic operations such as weighted arithmetic mean by quantitatively detecting detection values of the respective sensing portions 28 for example. As for the pressure distribution, the arithmetic unit 72 may be configured to detect a slip of the work when the position or shape of the pressure distribution constituted by the sensing portions 28 in the on-state for example has changed by a predetermined amount or more. In this case, an image processing technology and a machine learning technology may be used.

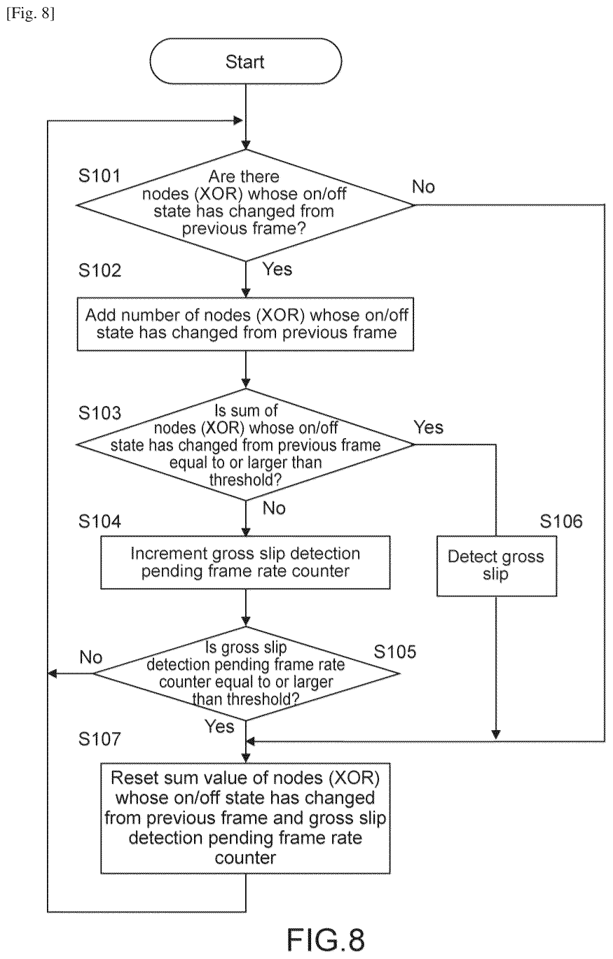

FIG. 8 is a flowchart showing an example of a gross slip detection procedure of the work W to be executed by the control unit 70. Here, the gross slip detection procedure of the work W in the state of gripping the work W with a pressure value associated with the low gripping command will be described.

First of all, the control unit 70 determines whether or not there are sensing portions 28 (node area) whose on/off state has changed (Step 101). This processing can use the determination method described with reference to A and B of FIG. 7.

Subsequently, the control unit 70 adds the number of sensing portions 28 whose on/off state has changed from the previous frame (Step 102) and determines whether or not this number is equal to or higher than a predetermined threshold (Step 103). In a case where it is lower than the threshold (No in Step 103), the control unit 70 increments a gross slip detection pending frame rate counter set in a memory such as the storage unit 74 and determines whether or not the gross slip detection pending frame rate counter is equal to or higher than the threshold (Steps 104 and 105). In a case where the gross slip detection pending frame rate counter is lower than the threshold, the control unit 70 repeats processing.

On the other hand, when the sum of the sensing portions 28 whose on/off state has changed reaches predetermined threshold, the control unit 70 determines that the gross slip of the work W has occurred and detects the gross slip of the work W (Step 106). When the control unit 70 detects a gross slip of the work W or the gross slip detection pending frame rate counter reaches the threshold, the control unit 70 resets the sum value of the sensing portions 28 whose on/off state has changed and the gross slip detection pending frame rate counter to zero (Step 107).

### Apparatus Control

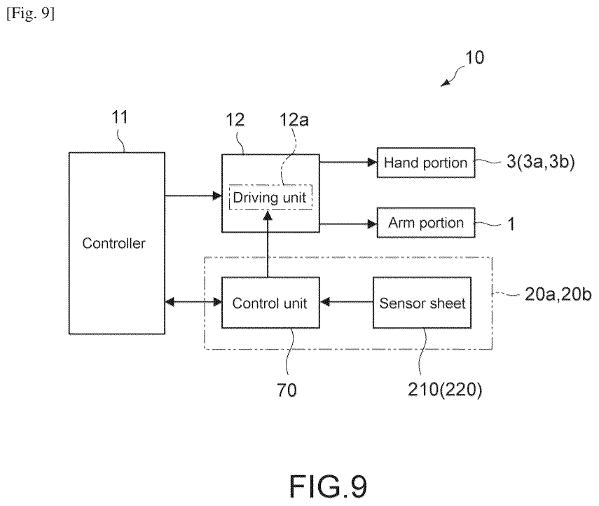

One example of apparatus control is provided in FIG. 9, which is a block diagram showing an example of a control system of the robot apparatus 10. The robot apparatus 10 includes the controller 11 and a driving portion 12. The driving portion 12 drives the arm portion 1, the hand portions 3, and the like. The driving portion 12 includes the driving unit 12a that drives the finger portions 3a, 3b. The controller 11 is configured to be capable of executing a control program for operating the robot apparatus 10 on the basis of input signals from the various sensors.

The sensor units 20a, 20b constitute one of various sensors and are attached to work gripping surfaces of the hand portion 3. Based on a control command from the controller 11, the sensor units 20a, 20b output gripping commands for gripping the work to the driving unit 12a that drives the finger portions 3a, 3b of the hand portion 3. The sensor units 20a, 20b detect compression forces (pressure distribution, gripping forces (normal load) or shearing forces) acting on the pressure detection surface S. The sensor units 20a, 20b calculate values of the compression forces in the control unit 70 and input the values to the controller 11. The controller 11 generates driving signals for controlling the positions and attitudes of the arm portion 1 and the hand portion 3 (finger portions 3a, 3b). The controller 11 outputs the driving signals to the driving portion 12. The driving portion 12 is typically an actuator such as an electric motor and a hydraulic cylinder. The driving portion 12 drives the arm portion 1, the hand portions 3, and the like on the basis of the driving signals from the controller 11.

As described above, in the present embodiment, the control unit 70 is configured to control gripping of the hand portions 3. The present technology is not limited thereto, and the controller 11 may output the gripping command directly to the driving unit 12a and control gripping of the hand portion 3. In this case, the control unit 70 only functions to calculate pressures acting on the sensor units 20a, 20b and output the pressures to the controller 11.

Next, an operation of the robot apparatus 10 according to the present embodiment will be described, associated with the details of the controller 11 and the control unit 70.

### Operation Example 1

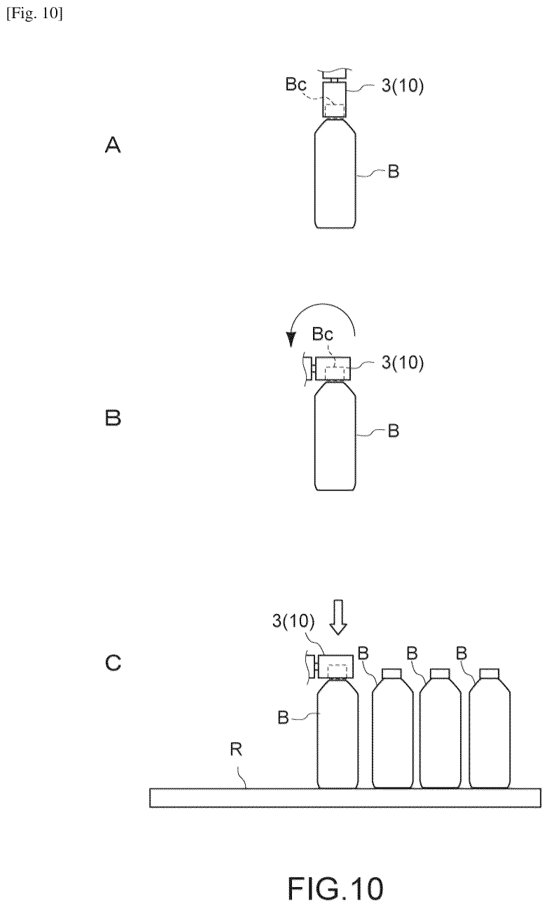

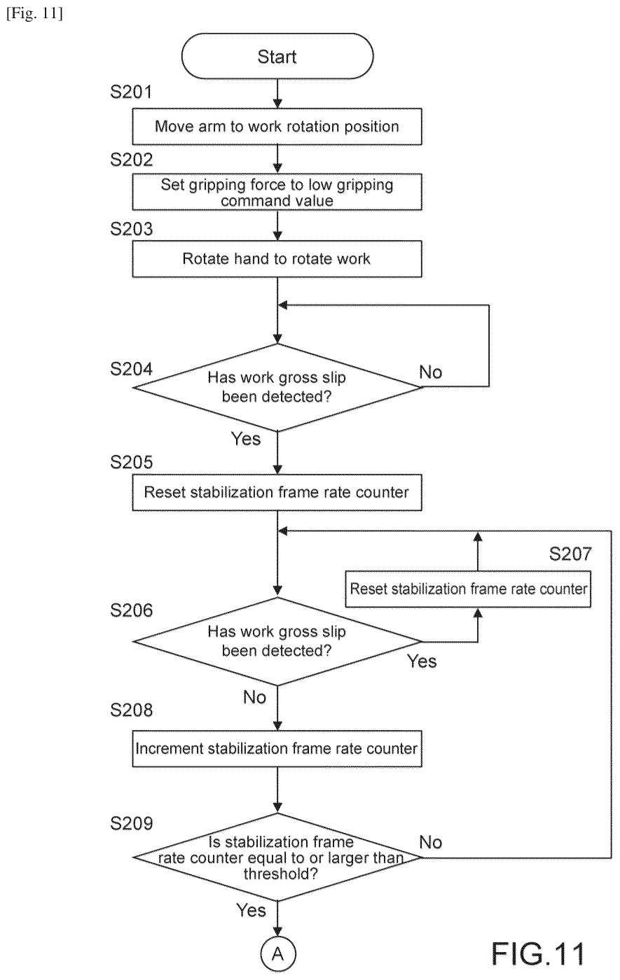

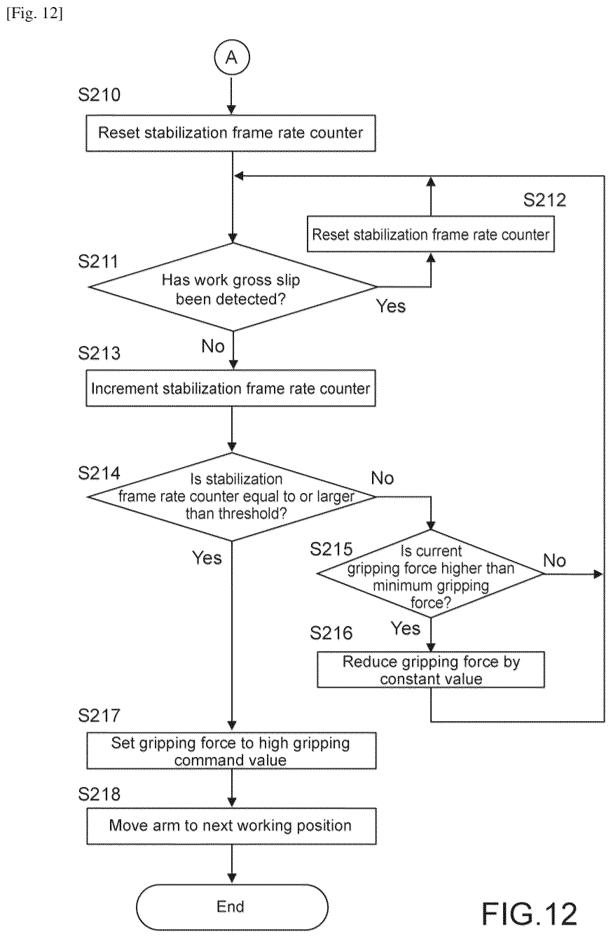

A to C of FIG. 10 are schematic views describing an operation example of placing bottles B as works on a shelf R one by one. FIGS. 11 and 12 are flowcharts showing the operation procedure of the robot apparatus 10 at this time.

In a task of picking up drink bottles in a box and displaying them on a shelf in a factory or store for example, a human automatically repositions a bottle gripped vertically downward in the hand to be horizontal so as to avoid the contact with upper and lower plates of the shelf and places the bottle. However, this method takes time to arrange and regrip the work at the middle point. It is a big problem in terms of the working speed and takt time.

In view of this, the working speed and takt time are improved by enabling an in-hand manipulation of repositioning the bottle B within the hand portion 3 and accordingly transporting the bottle B directly to a predetermined position on the shelf R in accordance with the present embodiment. Hereinafter, it will be described in detail.

As shown in A of FIG. 10, the robot apparatus 10 moves the arm portion 1 to a predetermined position on the shelf R (hereinafter, a work rotation position (also referred to as a position for rotating the hand portion with respect to the work)) while gripping a cap portion Bc of the bottle B with a high gripping force command value by the hand portion 3 (Step 201). At this time, the hand portion 3 is gripping the cap portion Bc in an attitude (first attitude) in which its distal end is oriented downward in a gravity direction (in the figure, on the lower side). Such an attitude of the hand portion 3 corresponds to an attitude when picking up one of the bottles B.

Subsequently, the robot apparatus 10 stops the arm portion 1 at the work rotation position and sets the gripping force of the band portion 3 to the low gripping command value (Step 202). Then, the robot apparatus 10 rotates, as shown in B of FIG. 10, the hand portion 3 so as to change an attitude (second attitude) in which the distal end of the hand portion 3 is oriented in a horizontal direction (in the figure, rightward) that is a direction orthogonal to the gravity direction, and rotates the work (bottle B) within the hand portion 3 due to its own weight (Step 203).

At this time, the control unit 70 executes gross slip detection of the work described with reference to FIG. 8 (Step 204). In a case where the control unit 70 has detected a gross slip (Yes in Step 204), the control unit 70 resets a stabilization frame rate counter set in a memory of the storage unit 74 for example (Step 205). The stabilization frame rate counter is referenced in order to determine whether or not the attitude is stabilized after the gross slip of the work ends.

After resetting the stabilization frame rate counter, the control unit 70 detects a gross slip of the work again (Step 206). In a case where the control unit 70 has detected a work gross slip (Yes in Step 206), the control unit 70 resets the stabilization frame rate counter and executes work gross slip detection again (Steps 207 and 206). In a case where no work gross slip has been detected (No in Step 206), the control unit 70 increments the stabilization frame rate counter and determines whether or not the stabilization frame rate counter is equal to or higher than a predetermined threshold (Steps 208 and 209). When the stabilization frame rate counter is lower than the threshold (No in Step 209), the control unit 70 repeats the processing of Steps 206 to 208.

series of processing (Steps 204 to 209) are typically a processing flow performed right after the work rotation starts. The work (bottle B) is intended to be kept upright shown in FIG. 10 also during rotation of the hand portion 3. Therefore, these series of processing can monitor whether the work starts the rotation (gross slip) right after the hand portion 3 rotates in the hand portion 3 as intended.

On the other hand, in a case where the stabilization frame rate counter is equal to or higher than the threshold (Yes in Step 209), the control unit 70 resets the stabilization frame rate counter and executes the work gross slip detection again (Steps 210 and 211). In a case where the work gross slip has been detected (Yes in Step 211), the control unit 70 resets the stabilization frame rate counter and executes the work gross slip detection again (Steps 212 and 211). In a case where no work gross slip has been detected (No in Step 211), the control unit 70 increments the stabilization frame rate counter and determines whether or not the stabilization frame rate counter is equal to or higher than the predetermined threshold (Steps 213 and 214).

These series of processing (Steps 210 to 214) are typically a processing flow performed right before the work rotation ends. When the distal end of the hand portion 3 finishes the rotation into the horizontal attitude shown in B of FIG. 10, the work (bottle B) is intended to be kept upright as shown in B of FIG. 10. However, the hand portion 3 rotates the work a little during the rotation of the hand portion 3 in some cases. In those cases, the work is not kept upright. There is thus a possibility that the work will not be stably placed on the shelf R. In order to avoid it, processing of further reducing the gripping force of the hand portion 3 to prevent work fall and promoting recovery to the upright attitude of the work is executed as described below.

In a case where the stabilization frame rate counter is lower than the predetermined threshold (No in Step 214), the control unit 70 determines whether or not the current gripping force of the hand portion 3 is higher than the minimum gripping force (Step 215). In a case where the current gripping force of the hand portion 3 is higher than the minimum gripping force (Yes in Step 215), the control unit 70 reduces the gripping force by a constant value and executes the work gross slip detection again (Steps 216 and 211). On the other hand, in a case where the current gripping force is the minimum gripping force (No in Step 215), the control unit 70 executes the work gross slip detection again without reducing the gripping force (Step 211). By repeating such processing until the stabilization frame rate counter is equal to or higher than the threshold (Yes in Step 214), the work (bottle B) can be reliably kept upright after the rotational operation of the hand portion 3 ends. Note that these series of processing (Steps 210 to 216) may be omitted in a case where the work can be stably kept upright.

In a case where the stabilization frame rate counter is equal to or higher than the predetermined threshold (Yes in Step 214), the control unit 70 sets the gripping force of the hand portion 3 to the high gripping command value and moves the arm portion 1 to a height for placing the work (bottle B) at the next working position (in the example of C of FIG. 10, the upper surface of the shelf R) (Steps 217 and 218). Then, the control unit 70 cancels the gripping force of the hand portion 3 to complete the task of placing the bottle B on the shelf R.

As described above, the gripping direction can be changed without regripping the work in accordance with the present embodiment. The working speed and takt time can be thus improved.

### Operation Example 2

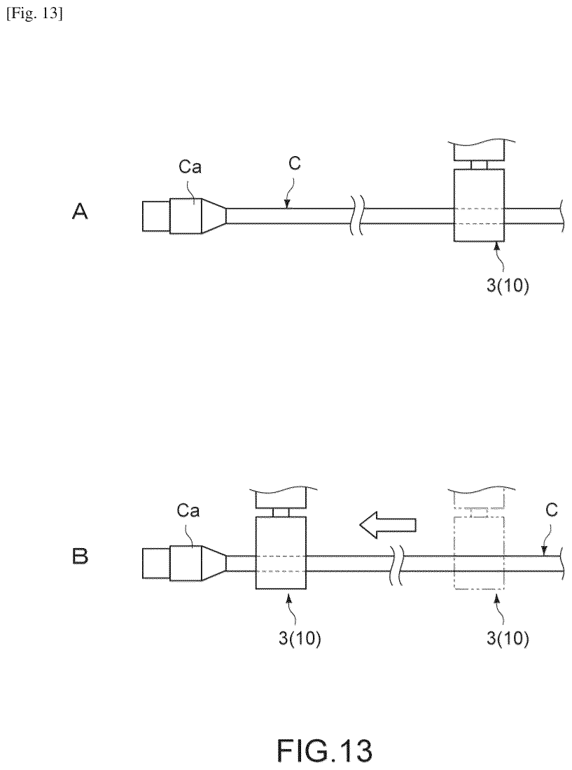

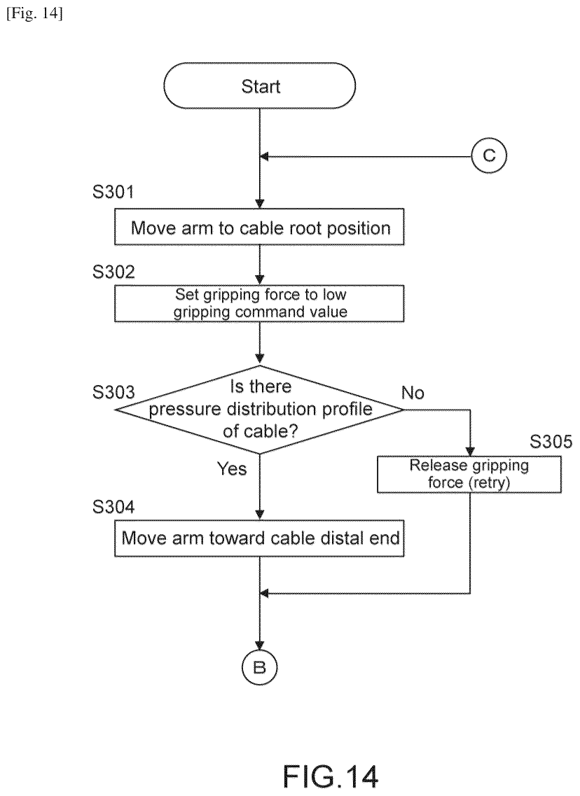

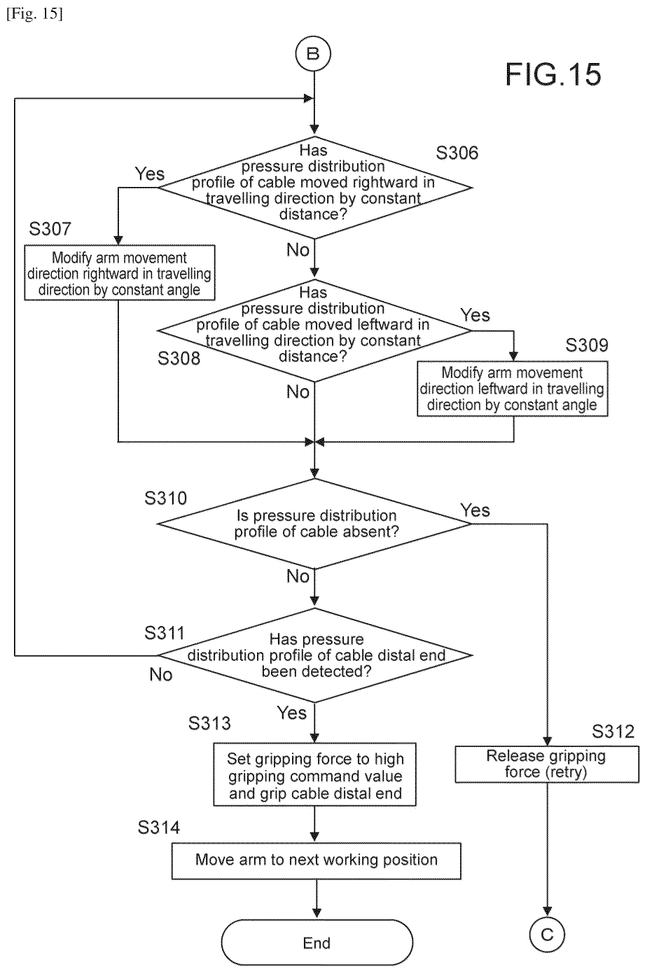

A and B of FIG. 13 are schematic views describing an operation example of moving the hand portion 3 gripping a cable C to a distal end Ca of the cable C. FIGS. 14 and 15 are flowcharts showing the operation procedure of the robot apparatus 10 at this time.

A task of picking up a connector attached to the end of the cable in a factory or the like has a problem in that it is difficult to determine a gripping position with a camera due to the connector's position that varies depending on how cables are curved or how cables are bundled. In such a case, a wide angle camera capable of recognizing all the connector's positions may be used, but such a camera is expensive and increases the cost. It is also a problem because camera-based image recognition generally takes time and increases the working takt time, and also increases the system calculation cost.

In view of this, in accordance with the present embodiment, moving the distal end Ca of the cable C closer to the hand portion 3 while gripping the cable C by the hand portion 3 improve the working takt time and the system calculation cost without the needs for a wide angle camera and high-accuracy image processing regardless of the form of the cable C. Hereinafter, it will be described in detail.

As shown in A of FIG. 13, the robot apparatus 10 moves the arm portion 1 to an arbitrary part (e.g., root position) of the cable C, sets the gripping force of the hand portion 3 to the low gripping command value, and then grips a part of the cable C (Steps 301 and 302). As for gripping of the cable C, for example an arbitrary part of the cable C disposed in an arbitrary form at a preset gripping position may be gripped by executing a constant gripping sequence. Alternatively, an arbitrary part of the cable C may be gripped using a camera mounted on an arbitrary part such as an arm portion.

Subsequently, the control unit 70 determines whether or not there is a predetermined pressure distribution profile on the basis of the outputs of the sensor units 20a, 20b of the hand portion 3 gripping the cable C (Step 303). The predetermined pressure distribution profile is for example such a pressure distribution that the sensing portions 28 whose pressure detection value is equal to or higher than a predetermined threshold extend across the gripping surface in one axis direction. In a case where the presence of such a pressure distribution profile has been detected (Yes in Step 303), the control unit 70 moves the arm portion 1 in a longitudinal direction of the cable C toward the distal end of the cable C (Step 304). On the other hand, in a case where pressure distribution profile has not been detected, the control unit 70 determines that a desired gripping state is not obtained, releases the gripping force of the band portion 3, and executes the gripping operation again (Step 305).

When moving the arm portion 1 toward the distal end of the cable C, the control unit 70 determines whether or not the pressure distribution profile detected by the sensor units 20a, 20b of the hand portion 3 has moved rightward by a constant distance or more with respect to the travelling direction (Step 306). In a case where the control unit 70 determines that the pressure distribution profile has moved rightward (Yes in Step 306), the control unit 70 modifies the movement direction of the arm portion 1 rightward by a constant angle with respect to the travelling direction (Step 307).

On the other hand, in a case where the control unit 70 determines that the pressure distribution profile has moved rightward (No in Step 306), the control unit 70 determines whether or not pressure distribution profile has moved leftward by a constant distance or more with respect to the travelling direction (Step 308). In a case where the control unit 70 determines that the pressure distribution profile has moved leftward (Yes in Step 308), the control unit 70 modifies the movement direction of the arm portion 1 leftward by a constant angle with respect to the travelling direction (Step 309).

These series of processing (Steps 306 to 309) can maintain the gripping position of the cable C in a middle region of the gripping surface while moving the arm portion 1.

Subsequently, the control unit 70 determines whether or not there is a predetermined pressure distribution profile again on the basis of the outputs of the sensor units 20a, 20b (Step 310). This processing is for checking whether fall of the cable C from the hand portion 3 or great deviation from the gripping position has occurred or not in the operation process of moving the cable C closer. If the cable C falls from the hand portion 3 (Yes in Step 310), the control unit 70 releases the gripping force and repeats gripping operation procedure (Steps 312 and 301 to 305).

When the control unit 70 has confirmed the presence of predetermined pressure distribution profile, the control unit 70 determines whether or not the pressure distribution profile at the distal end of the cable C has been detected (Step 311). The pressure distribution profile at the distal end of the cable is a pressure distribution profile corresponding to a shape near the distal end Ca of the cable C and is prestored in the storage unit 74. The control unit 70 repeats the processing of Steps 306 to 310 until the pressure distribution profile at the distal end of the cable C is detected (No in Step 311).

On the other hand, when the control unit 70 detects the pressure distribution profile at the distal end of the cable C (Yes in Step 311), the control unit 70 sets the gripping force of the hand portion 3 to the high gripping command value and grips the distal end Ca of the cable C (Step 313). Accordingly, the operation of moving the cable C closer by the hand portion 3 ends. Then, moving the arm portion 1 to the next working position transports the cable C to working position (Step 314).

As described above, in accordance with the present embodiment, the hand portion 3 can move a flexible linear member like the cable C to a desired position from any position. Therefore, the cable C can be transported in a desired attitude to the next step. Various linear members such as wires and hoses can be applied as the cable C other than wire members with a connection plug such as a connector and harness.

### Modified Examples

As discussed above, various modifications of the disclosed apparatus may be implemented in accordance with the present disclosure, such as a wearable device which is a gripping apparatus that has a sensing system for grip control as described above. For example, the wearable device may be a glove with a hand portion and finger portions with gripping surfaces capable of detecting a pressure distribution on the respective gripping surfaces. In some examples, the gripping apparatus may be implemented in a virtual reality application or augmented reality application. In one example embodiment, the gross slip of the work W with respect to the hand portion 3 is detected based on whether or not the number of sensing portions 28 whose on/off state has changed reaches the predetermined threshold, though not limited thereto. For example, the sensor unit having the sensor structure shown in FIG. 5 may detect the gross slip of the work also considering the magnitude and direction of the shearing force as well as the pressure detection value. This can detect the slip direction of the work. Therefore, whether the slip direction of the work is appropriate can be determined.

Moreover, in embodiment, the change of the capacitance detection element is used for detecting the pressure distribution, though not limited thereto. For example a variable-resistance detection element with a variable resistance value or the like may be used in accordance with the magnitude of the pressure.

In an example of a gripping apparatus which is a wearable device, various different applications may exist. For example, a glove apparatus may enable a technique of a skilled craftsman to be passed to a less experienced user of the glove. In an example, gloves with pressure sensors (e.g., sensor sheets) placed on the finger portions of the gloves may sense data of a skilled craftsman working, which is recorded and analyzed such that feedback may be provided to the less experienced user of a glove to correct grip on the work (e.g., a paintbrush). Thus, training of craftsman's skills or traditional skills may be implemented using a glove apparatus. For example, a glove apparatus training may include training to improve sports skills using equipment such as bats, rackets, and golf clubs. In other examples, a glove apparatus training may include training to improve skills using brushes and pens, such as painting calligraphy, and penmanship. In other examples, a glove apparatus training may include training to improve musical instrument playing skills such as piano and guitar.

In another example of a gripping apparatus which is a wearable device, a glove apparatus may assist with work of a user, such as routine or monotonous tasks (e.g., screw tightening) or where fine details are required, where the gloves ensure sufficient grip control while detecting the human force and compensating for a difference (e.g., shortage of force) to manipulate a screwdriver or the like with relative ease. Thus, training or assistance of simple tasks or advanced work assistance may be implemented using a glove apparatus. For example, a glove apparatus training or assistance may include making foods, such as Japanese sweets or gyoza, frying fried rice or wok spinning. In other examples, a glove apparatus training or assistance may include proper cap tightening work at a chemical factory, electronic equipment production work, such as working a soldering iron, connector insertion, or the like. In other examples, a glove apparatus training or assistance may be for medical practice tasks, such as operation on patients, diagnosis of conditions (e.g., swollen lymph nodes), or physical therapy. In other examples, a glove apparatus training or assistance may be for sheet metal processing accuracy evaluation for airplanes and automobiles, such as touch evaluation of parts.

In another example of a gripping apparatus which is a wearable device, a glove apparatus may provide for remote control of work by a user, such as performing remote instruction of a gripping apparatus (e.g., robotic arm), for example to manipulate a clamp or other tool remotely. Thus, remote tool use may be implemented using a glove apparatus. For example, a glove apparatus be used for training or for cleaning work using a remote robot, such as picking up garbage, cleaning baths and toilets, or the like. In other examples, a glove apparatus be used for training or for work in extreme areas using remote robots, such as disaster response or rescue, excavation of ruins, nuclear material processing, or space development. In other examples, a glove apparatus for training or for equipment repair services using remote robots, or for instructions on how to use equipment. In other examples, a glove apparatus for training or for shopping using a remote robot, which may enable a consumer to touch and hold a product remotely to confirm suitable size or weight characteristics. In other examples, a glove apparatus may be used for a virtual handshake event for idols or celebrities using remote robots.

Many other examples of a wearable device exist. In one example, a glove may have a hand portion which includes a full glove with finger portions for all fingers and a thumb. In another example, the glove may be a partial glove which omits some portion, such as omitting one or more finger portions, or is without a palm portion between the finger portions. A wearable device may include a wearable wrist portion, or may be otherwise wearable. Such wearable devices which include finger portions with pressure sensors for detecting slip of the work to reposition a hand portion or the like relative to the position of work.

In one example of the present disclosure, multiple or all of the finger portions are repositioned on the work. In another example, only one finger portion is repositioned to avoid slippage while maintaining at least two points of contact on the work besides the repositioned finger portion.

It should be appreciated that in an embodiment of a glove apparatus, the hand portion may not contact the work in some cases, and only the finger portion(s) may contact the work. Also, the user's fingers or hand may or may not directly contact the work, where for example, the glove may apply pressure on the work from the user's fingers. Further, the glove itself may be unable to on its own grip the work, but only through the hand of the user who is wearing the glove, which grips the work through the glove. As described herein, the term “work” should be understood to refer to any suitable item, such as tool, pen, workpiece, article of manufacture, or the like which may be manipulated by the user for any of various possible purposes. Thus, the work is not limited to any particular example presented herein.

It should be noted that the present technology may also take the following configurations.
(1) A robot apparatus, including:
a hand portion with a plurality of finger portions respectively having gripping surfaces capable of gripping a work;
a sensor unit provided in at least one of the plurality of finger portions and capable of detecting a pressure distribution on the gripping surface; and
a control apparatus configured to detect a slip of the work on the gripping surface on the basis of an output of the sensor unit and generate a control command to change a relative position of the hand portion with respect to the work.
(2) The robot apparatus according to (1), in which
the sensor unit is constituted by an elastically deformable sensor sheet having a plurality of capacitive elements that detects a pressure acting on the gripping surface, and
the control apparatus detects the slip of the work on the gripping surface on the basis of a change over time in pressure detected by the plurality of capacitive elements.
(3) The robot apparatus according to (2), in which
the control apparatus detects the slip of the work on the gripping surface when the number of capacitive elements whose pressure detection value has changed within a predetermined time becomes a predetermined number or more.
(4) The robot apparatus according to (2), in which
the control apparatus detects the slip of the work on the gripping surface when a pressure center position or a pressure distribution calculated on the basis of pressure detection values of the plurality of capacitive elements changes within a predetermined time.
(5) The robot apparatus according to any one of (1) to (4), in which
the control apparatus generates, as the control command, from a state of gripping the work with a first gripping force, a pressure adjustment command to adjust the work from the first gripping force to a second gripping force lower than the first gripping force and a movement command to change the relative position of the hand portion with respect to the work.
(6) The robot apparatus according to (5), in which
the control apparatus generates, as the movement command, a control command to change from a first attitude in which a distal end of the hand portion is oriented downward in a gravity direction to a second attitude in which the distal end of the hand portion is oriented in a direction orthogonal to the gravity direction.
(7) The robot apparatus according to (5) or (6), in which
the control apparatus generates, as the movement command, a control command to move in a longitudinal direction of the work.
(8) The robot apparatus according to (2), in which
the sensor sheet is constituted by a pressure sensor, the pressure sensor including a sensor electrode layer in which the plurality of capacitive elements is arranged in a matrix form, a reference electrode layer connected to a reference potential, and a deformation layer disposed between the sensor electrode layer and the reference electrode layer.
(9) The robot apparatus according to (2), in which
the sensor sheet includes
a pair of pressure sensors, the pressure sensors each having a sensor electrode layer in which the plurality of capacitive elements is arranged in a matrix form, a reference electrode layer connected to a reference potential, and a deformation layer disposed between the sensor electrode layer and the reference electrode layer, and
a separation layer constituted by a viscoelastic material disposed between the pair of pressure sensors.
(10) A control method for a robot apparatus, including:
detecting a slip of a work on a gripping surface on the basis of an output of a sensor unit capable of detecting a pressure distribution on the gripping surface of a hand portion capable of gripping the work; and
generating a control command to change a relative position of the hand portion with respect to the work.
(11) An apparatus, comprising:
a hand portion with a plurality of finger portions respectively having gripping surfaces capable of gripping a work;
a sensor unit provided in at least one of the plurality of finger portions and capable of detecting a pressure distribution on the gripping surface; and
a control apparatus configured to detect a slip of the work on the gripping surface based on an output of the sensor unit and change a relative position of the hand portion with respect to the work.
(12) The apparatus according to (11), wherein
the sensor unit includes an elastically deformable sensor sheet having a plurality of capacitive elements that detects a pressure applied to the gripping surface, and
the control apparatus detects the slip of the work on the gripping surface based on a change in pressure detected by the plurality of capacitive elements.
(13) The apparatus according to (11) or (12), wherein
the control apparatus detects the slip of the work on the gripping surface responsive to a number of capacitive elements that have a pressure detection value changing, within a predetermined time, meeting a predetermined threshold.
(14) The apparatus according to (11) or (12), wherein
the control apparatus detects the slip of the work on the gripping surface responsive to a pressure center position or a pressure distribution calculated based on pressure detection values of the plurality of capacitive elements changes within a predetermined time.
(15) The apparatus according to (11) to (14), wherein
the control apparatus causes, from a state of gripping the work with a first gripping force, a pressure adjustment adjusting the work from the first gripping force to a second gripping force lower than the first gripping force and a movement changing the relative position of the hand portion with respect to the work.
(16) The apparatus according to (11) to (15), wherein
the control apparatus causes a change from a first attitude in which a distal end of the hand portion is oriented downward in a gravity direction to a second attitude in which the distal end of the hand portion is oriented in a direction orthogonal to the gravity direction.
(17) The apparatus according to (11) to (16), wherein
the control apparatus causes a movement in a longitudinal direction of the work.
(18) The apparatus according to (12) to (17), wherein
the sensor sheet comprises a pressure sensor, the pressure sensor including a sensor electrode layer in which the plurality of capacitive elements are arranged in a matrix form, a reference electrode layer, and a deformation layer disposed between the sensor electrode layer and the reference electrode layer.
(19) The apparatus according to (12) to (17), wherein
the sensor sheet includes
a pair of pressure sensors, the pressure sensors each having a sensor electrode layer in which the plurality of capacitive elements are arranged in a matrix form, a reference electrode layer, and a deformation layer disposed between the sensor electrode layer and the reference electrode layer, and
a separation layer comprising a viscoelastic material disposed between the pair of pressure sensors.
(20) The apparatus according to (11) to (19), wherein the apparatus is a robotic arm with the hand portion at one end of an arm portion.
(21) A control method for a hand portion of an apparatus, comprising:
detecting a slip of a work on a gripping surface based on an output of a sensor unit capable of detecting a pressure distribution on the gripping surface of at least one finger portion of hand portion capable of gripping the work; and
changing a relative position of the hand portion with respect to the work.
(22) The control method of (21), further comprising incrementing a gross slip detection frame rate counter.
(23) The control method of (22), further comprising determining whether the gross slip detection frame rate counter meets a threshold.
(24) The control method of (23), further comprising:
responsive to determining the gross slip detection frame rate counter meets the threshold, reset the gross slip detection frame rate counter to zero.
(25) The control method of (21) to (24), further comprising, for a first object, setting a gripping force to a first value.
(26) The control method of (21) to (25), further comprising determining whether a predetermined pressure distribution profile is present.
(27) The control method of (26), further comprising, responsive to the predetermined pressure distribution profile being present, setting the gripping force to a second value, the second value being greater than the first value.
(28) The control method of (26), further comprising, responsive to the predetermined pressure distribution profile not being present, release the gripping force.
(29) The control method of (28), further comprising, retry gripping the first object by setting the gripping force to the first value.
(30) A robot apparatus, comprising:
a hand portion with a plurality of finger portions respectively having gripping surfaces capable of gripping a work;
a sensor unit provided in at least one of the plurality of finger portions and capable of detecting a pressure distribution on the gripping surface; and
a control apparatus configured to detect a slip of the work on the gripping surface based on an output of the sensor unit and change a relative position of the hand portion with respect to the work.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

3a, 3b Finger portion
10 Robot apparatus
11 Controller
12 Driving portion
12a Driving unit
20a, 20b Sensor unit
21 Sensor unit
23 Separation layer
25 Reference electrode layer
27 Deformation layer
28 Sensing portion
30 Sensor electrode layer
70 Control unit
210, 220 Sensor sheet
W, C Work

1. An apparatus, comprising:
a hand portion with a plurality of finger portions respectively having gripping surfaces capable of gripping a work;
a sensor unit provided in at least one of the plurality of finger portions and capable of detecting a pressure distribution on the gripping surface;
and
a control apparatus configured to detect a slip of the work on the gripping surface based on an output of the sensor unit and change a relative position of the hand portion with respect to the work.

2. The apparatus according to claim 1, wherein
the sensor unit includes an elastically deformable sensor sheet having a plurality of capacitive elements that detects a pressure applied to the gripping surface, and
the control apparatus detects the slip of the work on the gripping surface based on a change in pressure detected by the plurality of capacitive elements.

3. The apparatus according to claim 2, wherein
the control apparatus detects the slip of the work on the gripping surface responsive to a number of capacitive elements that have a pressure detection value changing, within a predetermined time, meeting a predetermined threshold.

4. The apparatus according to claim 2, wherein
the control apparatus detects the slip of the work on the gripping surface responsive to a pressure center position or a pressure distribution calculated based on pressure detection values of the plurality of capacitive elements changes within a predetermined time.

5. The apparatus according to claim 1, wherein
the control apparatus causes, from a state of gripping the work with a first gripping force, a pressure adjustment adjusting the work from the first gripping force to a second gripping force lower than the first gripping force and a movement changing the relative position of the hand portion with respect to the work.

6. The apparatus according to claim 5, wherein
the control apparatus causes a change from a first attitude in which a distal end of the hand portion is oriented downward in a gravity direction to a second attitude in which the distal end of the hand portion is oriented in a direction orthogonal to the gravity direction.

7. The apparatus according to claim 5, wherein
the control apparatus causes a movement in a longitudinal direction of the work.

8. The apparatus according to claim 2, wherein
the sensor sheet comprises a pressure sensor, the pressure sensor including a sensor electrode layer in which the plurality of capacitive elements are arranged in a matrix form, a reference electrode layer, and
a deformation layer disposed between the sensor electrode layer and the reference electrode layer.

9. The apparatus according to claim 2, wherein
the sensor sheet includes
a pair of pressure sensors, the pressure sensors each having a sensor electrode layer in which the plurality of capacitive elements are arranged in a matrix form, a reference electrode layer, and a deformation layer disposed between the sensor electrode layer and the reference electrode layer, and
a separation layer comprising a viscoelastic material disposed between the pair of pressure sensors.

10. The apparatus according to claim 1, wherein
the apparatus is a robotic arm with the hand portion at one end of an arm portion.

11. A control method for a hand portion of an apparatus, comprising:
detecting a slip of a work on a gripping surface based on an output of a sensor unit capable of detecting a pressure distribution on the gripping surface of at least one finger portion of hand portion capable of gripping the work; and
changing a relative position of the hand portion with respect to the work.

12. The control method of claim 11, further comprising incrementing a gross slip detection frame rate counter.

13. The control method of claim 12, further comprising determining whether the gross slip detection frame rate counter meets a threshold.

14. The control method of claim 13, further comprising:
responsive to determining the gross slip detection frame rate counter meets the threshold, reset the gross slip detection frame rate counter to zero.

15. The control method of claim 11, further comprising, for a first object, setting a gripping force to a first value.

16. The control method of claim 15, further comprising determining whether a predetermined pressure distribution profile is present.

17. The control method of claim 16, further comprising, responsive to the predetermined pressure distribution profile being present, setting the gripping force to a second value, the second value being greater than the first value.

18. The control method of claim 16, further comprising, responsive to the predetermined pressure distribution profile not being present, release the gripping force.

19. The control method of claim 18, further comprising, retry gripping the first object by setting the gripping force to the first value.

20. A robot apparatus, comprising:
a hand portion with a plurality of finger portions respectively having gripping surfaces capable of gripping a work;
a sensor unit provided in at least one of the plurality of finger portions and capable of detecting a pressure distribution on the gripping surface; and
a control apparatus configured to detect a slip of the work on the gripping surface based on an output of the sensor unit and change a relative position of the hand portion with respect to the work.
